(19) United States
(12) Patent Application Publication
(10) Pub. No.: US 2026/0242227 A1
(43) Pub. Date: Aug. 20, 2026

(54) METHOD FOR TREATING ACTIVATED CARBON AND ACTIVATED CARBON TREATED BY SAID METHOD

(71) Applicants: VIDYASIRIMEDHI INSTITUTE OF SCIENCE AND TECHNOLOGY (VISTEC), Wangchan (TH); IRPC PUBLIC COMPANY LIMITED, Amphur Muang (TH)

(72) Inventors: Montree SAWANGPHRUK, Rayong (TH); Thitiphum SANGSANIT, Rayong (TH); Worapol TEJANGKURA, Rayong (TH); Ronnachai SONGTHAN, Rayong (TH); Nuttida MATKHAW, Rayong (TH)

(73) Assignees: VIDYASIRIMEDHI INSTITUTE OF SCIENCE AND TECHNOLOGY (VISTEC), Wangchan (TH); IRPC PUBLIC COMPANY LIMITED, Amphur Muang (TH)

(21) Appl. No.: 19/544,722

(22) Filed: Feb. 19, 2026

(30) Foreign Application Priority Data
Feb. 19, 2025 (TH) 2501001059

(51) Int. Cl. C01B 32/354; H01G 11/34; H01M 4/62

(52) U.S. Cl. CPC C01B 32/354; H01G 11/34; H01M 4/625; C01P 2004/03; C01P 2004/61; C01P 2006/11; C01P 2006/12; C01P 2006/40

(57) ABSTRACT

The present invention relates to a method for treating activated carbon, comprising the steps of: (a) reducing a particle size of a starting activated carbon to obtain activated carbon powder; (b) subjecting the activated carbon powder obtained from step (a) to a mechanofusion process to obtain activated carbon having spherical particles; and (c) subjecting the activated carbon having spherical particles obtained from step (b) to a heat treatment. Preferably, step (c) is carried out at a temperature in a range of 600-1,000° C. for 1-5 hours. The invention further relates to activated carbon produced by the above-described method, as well as to an energy storage device comprising such activated carbon.

### TECHNICAL FIELD

Chemistry related to a method for treating activated carbon and activated carbon treated by said method.

### BACKGROUND OF THE INVENTION

Activated carbon (AC) is a versatile material used extensively in various industries, particularly in water filtration and purification due to its large specific surface area, porosity, and high adsorption capacity.

One of the most commonly used low-cost activated carbons is derived from coconut shell, which is abundant, sustainable, and primarily utilized in water treatment applications. However, coconut shell-based activated carbon, despite its affordability and availability, is not optimized for energy storage applications such as supercapacitors. Its relatively low electrical conductivity, irregular particle morphology, and inadequate surface properties make it less suitable compared to high-performance activated carbons typically used in supercapacitors.

Premium-grade activated carbons are manufactured with precise control over their surface area and pore structure, making them highly efficient for energy storage but significantly more expensive up to 100 times more costly than low-cost grades used in water filtration. This high cost poses a barrier to widespread use in large-scale commercial applications.

Currently, high-performance activated carbon materials are typically produced through complex and multi-step processes, involving high-temperature activation, template synthesis, or chemical vapor deposition (CVD) methods, which increase both the production cost and environmental impact. Additionally, these methods often require high-purity precursors and advanced equipment, making them less suitable for industrial-scale production.

Thus, the development of cost-effective techniques to transform low-cost activated carbon into high-performance active materials for supercapacitors remains a significant challenge in the field.

Examples of the prior art related to the modification and applications of activated carbon, including some using low-cost sources, are as follows:

WO 2019/209938 A1 discloses a method for producing activated carbon from various waste sources such as bourbon stillage and spent grain through hydrothermal dehydration, optional carbonization, and subsequent activation using physical methods. The method involves development of high porosity and surface area. The resulting activated carbon is tailored for use in water filtration and purification applications, providing a cost-effective and sustainable alternative to traditional activated carbon.

U.S. Pat. No. 10,068,715 B2 discloses a method for producing activated carbon with a relatively high transition metal content and low covalent oxygen content, tailored specifically for use in electric double-layer capacitors (EDLCs). The method involves heating a carbon precursor to a high carbonization temperature, followed by a physical activation step using steam or carbon dioxide gas. The controlled activation results in an activated carbon with a high specific surface area, large pore volume, and reduced levels of covalent oxygen, ensuring high energy density and stable performance in EDLCs. This US patent further describes the importance of balancing the metal content to improve electrical conductivity while minimizing undesired chemical interactions that could adversely affect device performance.

WO 2015/013345 A1 discloses a method for preparing activated carbon designed for high-voltage EDLCs. The method utilizes a phenolic novolac resin as the carbon precursor, which is carbonized and subsequently activated using carbon dioxide gas to create a high-purity activated carbon material. The activation process is controlled to tailor the pore size distribution and increase the specific surface area, making the activated carbon suitable for use in high-voltage EDLCs.

JP 2009105186 A discloses a method for producing low-cost activated carbon for EDLC electrodes using cotton as the starting raw material for carbonization. The carbonization process involves heating cotton fibers at high temperatures, followed by an alkaline activation step in an inert atmosphere to produce activated carbon with a high specific surface area and micropore structure.

Although approaches for the development and improvement of low-cost activated carbon have been disclosed, as exemplified by the aforementioned patent documents, there remains a need to develop methods for further enhancing the performance characteristics of activated carbon.

### SUMMARY OF THE INVENTION

The present invention is directed to addressing limitations of low-cost activated carbon, particularly activated carbon produced from coconut shells, which is commonly used in filtration and water treatment applications. A primary objective of the invention is to develop a method for improving the properties of activated carbon so as to enhance its physical and chemical characteristics, such as electrical conductivity, particle dispersion, structure and surface area, bulk density, and structural stability. These improvements increase the performance potential of activated carbon and expand its scope of applications, especially in energy storage technologies.

Another objective of the invention is to provide improved activated carbon suitable for use as an electrode material, a component, or a conductive additive in energy storage devices, such as supercapacitors and hybrid capacitors.

In one aspect, the invention relates to a method for treating activated carbon, comprising the steps of:
(a) reducing a particle size of a starting activated carbon to obtain activated carbon powder;
(b) subjecting the activated carbon powder obtained from step (a) to a mechanofusion process to obtain activated carbon having spherical particles; and
(c) subjecting the activated carbon having spherical particles obtained from step (b) to a heat treatment,
wherein step (c) is carried out at a temperature in a range of 600-1,000° C. for 1-5 hours.

In another aspect, the invention further relates to activated carbon treated according to the method of the invention, which preferably has a specific surface area in a range of 200-900 m²/g and a bulk density in a range of 0.3-0.5 g/cm³.

The invention also relates to an energy storage device comprising the activated carbon treated and having the properties according to the invention.

The method for treating activated carbon according to the invention can significantly improve the properties of low-cost activated carbon or water filtration grade activated carbon by employing physical and thermal processes, such as a ball milling process and particle spherification via a mechanofusion technique. Notably, the method does not require the use of solvents, catalysts, or additional chemicals. As a result, the method offers several advantages, including suitability for industrial-scale production, simple operational steps and equipment, and operation under environmentally friendly conditions.

The modification of activated carbon particle morphology into a spherical shape according to the invention improves particle packing uniformity and bulk density, which directly contributes to enhanced overall electrode performance. Furthermore, when the activated carbon subjected to mechanofusion is further heat-treated under an argon atmosphere containing hydrogen in an amount of 1-10%, for example about 5%, the structural stability, electrical conductivity, and surface properties of the activated carbon can be further improved.

Experimental results of the invention demonstrate that improving the properties of low-cost water filtration grade activated carbon according to the method of the invention yields activated carbon having electrochemical performance comparable or equivalent to that of commercially available high-performance activated carbon. This provides a cost-effective alternative suitable for large-scale energy storage systems. The improved activated carbon exhibits enhanced characteristics in multiple aspects, including high specific surface area, appropriate bulk density, and improved particle structure and morphology. With these properties, the resulting activated carbon is highly suitable for use as an electrode material in supercapacitors.

An additional advantage of the invention lies in the use of low-cost and locally available starting materials. Low-cost water filtration grade activated carbon derived from coconut shells is not only economically advantageous but also promotes sustainability and aligns with global efforts to reduce dependence on high-cost carbon raw materials. Moreover, the improved activated carbon can be applied in a wide range of energy storage technologies, including supercapacitors, hybrid capacitors, and lithium-ion batteries, as well as for use as a catalyst support material and in other chemical processing applications.

### BRIEF DESCRIPTION OF THE DRAWINGS

FIG. 1 is a set of photographs showing particle morphologies of water filtration grade activated carbon before and after modification, wherein:

FIG. 1(a) shows a water filtration grade activated carbon sample as received, without any modification (hereinafter referred to as WFG-AC);

FIG. 1(b) shows a water filtration grade activated carbon sample subjected to milling (hereinafter referred to as WFG-BM); and

FIG. 1(c) shows a water filtration grade activated carbon sample subjected to both milling and particle shape modification by a mechanofusion process (hereinafter referred to as WFG-BM+MF).

FIG. 2 shows field emission scanning electron microscope (FESEM) images illustrating surface morphologies of activated carbon samples, wherein:

FIGS. 2(a) and 2(b) show a first type of commercially available supercapacitor-grade activated carbon (hereinafter referred to as HP-AC1);

FIGS. 2(c) and 2(d) show a second type of commercially available supercapacitor-grade activated carbon (hereinafter referred to as HP-AC2);

FIGS. 2(e) and 2(f) show water filtration grade activated carbon as received (WFG-AC);

FIGS. 2(h) and 2(i) show water filtration grade activated carbon subjected to milling (WFG-BM); and

FIGS. 2(j) and 2(k) show water filtration grade activated carbon subjected to both milling and particle spherification by mechanofusion (WFG-BM+MF).

FIGS. 3(a) and 3(b) are graphs showing Brunauer-Emmett-Teller (BET) analysis results of the first commercially available supercapacitor-grade activated carbon (HP-AC1) compared with water filtration grade activated carbon samples after each treatment step, including milling (WFG-BM 3 h, WFG-BM 6 h, and WFG-BM 9 h), mechanofusion (WFG-BM+MF), and heat treatment or annealing (hereinafter referred to as WFG-BM+MF+AN).

FIGS. 4(a) and 4(b) are graphs showing bulk density measurement results obtained using the ASTM D2854-96 (2015) standard test method for the first and second commercially available supercapacitor-grade activated carbon samples (HP-AC1 and HP-AC2) compared with water filtration grade activated carbon as received (WFG-AC) and samples subjected to successive treatments, including milling (WFG-BM), mechanofusion (WFG-BM+MF), and heat treatment or annealing (WFG-BM+MF+AN).

FIG. 5 is a graph showing thermogravimetric analysis (TGA) results of the first commercially available supercapacitor-grade activated carbon (HP-AC1), water filtration grade activated carbon (WFG-AC), and water filtration grade activated carbon subjected to milling, mechanofusion, and heat treatment or annealing (WFG-BM+MF+AN), wherein:

FIG. 5(a) shows TGA results in a temperature range of 30-130° C.; and

FIG. 5(b) shows remaining mass as a function of increasing temperature.

FIG. 6 is a graph showing electrochemical performance test results of a cylindrical supercapacitor fabricated using commercially available supercapacitor-grade activated carbon (HP-AC1), wherein:

FIG. 6(a) shows testing according to the IEC standard at 2.7 V;

FIG. 6(b) shows galvanostatic charge-discharge (GCD) profiles at various current rates;

FIG. 6(c) shows rate capability evaluation at currents ranging from 100-5,000 mA;

FIG. 6(d) shows GCD profiles illustrating internal resistance (IR) drop during performance testing;

FIG. 6(e) shows cycling stability under constant current (CC) charge-discharge at 5,000 mA; and

FIG. 6(f) shows energy efficiency analysis at 5,000 mA.

FIG. 7 is a graph showing electrochemical performance test results of a cylindrical supercapacitor fabricated using ball-milled water filtration grade activated carbon (WFG-BM), wherein:

FIG. 7(a) shows testing in accordance with the IEC standard at 2.7 V;

FIG. 7(b) shows galvanostatic charge-discharge (GCD) profiles at various current rates;

FIG. 7(c) shows rate capability evaluation at currents ranging from 100-5,000 mA;

FIG. 7(d) shows galvanostatic charge-discharge (GCD) profiles illustrating internal resistance (IR) drop during performance testing;

FIG. 7(e) shows cycling stability testing under constant current (CC) charge-discharge at 5,000 mA; and

FIG. 7(f) shows energy efficiency analysis at 5,000 mA.

FIG. 8 is a graph showing electrochemical performance test results of a cylindrical supercapacitor fabricated using water filtration grade activated carbon subjected to milling and mechanofusion (WFG-BM+MF), wherein:

FIG. 8(a) shows testing in accordance with the IEC standard at 2.7 V;

FIG. 8(b) shows galvanostatic charge-discharge (GCD) profiles at various current rates;

FIG. 8(c) shows rate capability evaluation at currents ranging from 100-12,000 mA;

FIG. 8(d) shows galvanostatic charge-discharge (GCD) profiles illustrating internal resistance (IR) drop during performance testing;

FIG. 8(e) shows cycling stability testing under constant current (CC) charge-discharge at 5,000 mA; and

FIG. 8(f) shows energy efficiency analysis at 5,000 mA.

FIG. 9 is a graph showing electrochemical performance test results of a cylindrical supercapacitor fabricated using water filtration grade activated carbon treated according to the method of the present invention (WFG-BM+MF+AN), wherein:

FIG. 9(a) shows testing in accordance with the IEC standard at 2.7 V;

FIG. 9(b) shows galvanostatic charge-discharge (GCD) profiles at various current rates;

FIG. 9(c) shows rate capability evaluation at currents ranging from 100-12,000 mA;

FIG. 9(d) shows galvanostatic charge-discharge (GCD) profiles illustrating internal resistance (IR) drop during performance testing;

FIG. 9(e) shows cycling stability testing under constant current (CC) charge-discharge at 5,000 mA; and

FIG. 9(f) shows energy efficiency analysis at 5,000 mA.

FIG. 10 is a graph showing long-term cycling stability results after 50,000 charge-discharge cycles at a current of 5,000 mA for cylindrical supercapacitors fabricated using different types of activated carbon as electrode materials.

### DETAILED DESCRIPTION

Any aspects shown herein shall encompass the application to other aspects of the present invention as well, unless specified otherwise.

Any tools, devices, methods, materials, or chemicals mentioned herein, unless specified otherwise, mean the tools, devices, methods, materials, or chemicals generally used or practiced by a person skilled in the art, unless explicitly specified as special or exclusive tools, devices, methods, or chemicals for the present invention.

The terms “comprise(s),” “consist(s) of,” “have/has,” “contain(s),” and “include(s)” are open-end verbs. For example, any method which “comprises,” “consists of,” “has,” “contains” or “includes” one component or multiple components or one step or multiple steps is not limited to only one component or one step or multiple steps or multiple components as specified, but also encompasses components or steps that are not specified.

All components and/or methods disclosed and claimed in the present invention are intended to cover the aspects of the invention obtained from an action, a practice, a modification or a change of any factors which does not require any experiment that is substantially different from the present invention and gives properties and utility and provides the same effect as the aspects according to the present invention according to the judgement of a person of ordinary skill in the art, although not specifically stated in the claims. Therefore, substitutions or analogues of the aspects according to the present invention, including any slight modifications or changes that are clearly apparent to a person of ordinary skill in the art, are considered to be within the spirit, the scope, and the concept according to the present invention as well.

Technical and scientific terms used herein have meanings as understood by a person of ordinary skill in the art, unless specified otherwise.

Any numerical range recited herein is intended to include all subranges encompassed therein, as well as each individual numerical value within such range, including fractional and integer values. In addition, any stated value includes all values that, when rounded, would be equal to the stated value.

### Method for Treating Activated Carbon According to the Invention

The present invention provides an approach for developing and improving low-cost water filtration grade activated carbon, such as commercially available activated carbon produced from coconut shells, to impart properties of a high-performance carbon material suitable for use as an electrode in electrical energy storage devices, such as supercapacitors.

The method according to the invention comprises three main steps, namely reducing a particle size of a starting activated carbon, modifying a surface morphology of the activated carbon into a spherical shape through a mechanofusion process, and performing a heat treatment under an inert atmosphere. Details are described below.

The method for treating activated carbon comprises the steps of:
(a) reducing a particle size of a starting activated carbon to obtain activated carbon powder;
(b) subjecting the activated carbon powder obtained from step (a) to a mechanofusion process to obtain activated carbon having spherical particles; and
(c) subjecting the activated carbon having spherical particles obtained from step (b) to a heat treatment.

Preferably, step (c) is carried out at a temperature in a range of 600-1,000° C. for 1-5 hours.

By way of example, step (a) is performed by milling using a ball milling machine or a high-energy ball milling machine, with a rotational speed of a milling pot in a range of 2.5-6.0 Hz or a milling speed in a range of 150-600 rpm for 3-12 hours.

More preferably, step (a) is performed at a milling speed in a range of 200-400 rpm, more preferably 250-350 rpm, for 3-12 hours, and most preferably for 7-9 hours.

In a more specific embodiment, the milling is performed using a high-energy ball milling machine comprising an inner milling pot and an outer milling pot, wherein a milling speed of the inner milling pot is in a range of 300-1,800 rpm and a milling speed of the outer milling pot is in a range of 150-600 rpm for 3-12 hours, more preferably for 7-9 hours.

In one embodiment, the milling is carried out using a mass ratio of the starting activated carbon to a milling ball of 1:0.5-2, preferably 1:1. This ratio is particularly important because if the mass ratio of milling ball is too low relative to the starting activated carbon, the material may not be milled to the desired particle size, resulting in a longer milling time. Conversely, if the mass ratio of milling balls is too high relative to the starting activated carbon, the amount of activated carbon that can be loaded into the process is limited, thereby reducing production efficiency, especially at an industrial scale.

Preferably, the activated carbon powder obtained from step (a) has a particle size in a range of 1-5 micrometers, more preferably 2-4 micrometers, and most preferably 2.5-3.5 micrometers.

Examples of starting activated carbon suitable for use in the invention include water filtration grade activated carbon, coconut shell-based activated carbon, and mixtures thereof.

In a more specific embodiment, in step (b), the mechanofusion process is performed under an inert gas atmosphere at a rotational speed in a range of 500-5,000 rpm for 30-60 minutes, preferably at a rotational speed in a range of 4,000-5,000 rpm for 30-40 minutes.

The activated carbon having spherical particles obtained from step (b) preferably has a particle size in a range of 2-6 micrometers.

By way of example, step (c) is performed by annealing under an inert gas atmosphere at a temperature in a range of 800-900° C. for 2-3 hours.

Preferably, the annealing is carried out under an inert gas atmosphere comprising hydrogen in an amount of 1-10%, more preferably 1-5%, and most preferably an inert gas atmosphere comprising hydrogen in an amount of 4-5%.

### Activated Carbon Treated According to the Invention

The activated carbon treated according to the method of the present invention preferably has a specific surface area in a range of 200-900 m²/g, more preferably 400-900 m²/g, even more preferably 600-900 m²/g, and most preferably 800-900 m²/g, and a bulk density in a range of 0.3-0.5 g/cm³, preferably 0.3-0.45 g/cm³.

The activated carbon treated according to the invention is suitable for use as, or as part of, an electrode material, a component, or a conductive additive in energy storage devices, particularly supercapacitors, hybrid capacitors, or batteries, such as lithium-ion batteries.

The method for treating activated carbon according to the present invention offers significant advantages over methods disclosed in the prior art, as it enables improvement of both physical and electrochemical properties of activated carbon using low-cost raw materials, without requiring complex equipment, while employing techniques that are scalable for industrial production. In addition, the method does not require the use of solvents or additional chemical activating agents and is environmentally friendly.

### Examples

The present invention will now be described in more detail with reference to the following examples and experimental results in conjunction with the accompanying drawings. It should be understood that the examples described herein are provided for illustrative purposes only and are not intended to limit the scope of the invention in any manner.

To investigate the effects of each processing step on the properties of activated carbon, experimental studies were conducted by preparing activated carbon samples according to the procedures described below.

### 1. Preparation of Samples

### 1.1 Reduction of Particle Size of Starting Activated Carbon

Objective: To reduce particle size and improve particle dispersion of activated carbon in order to enhance performance in subsequent processing steps.

Materials: Water filtration grade activated carbon (hereinafter referred to as WFG-AC) in an amount of 100-300 g, and a milling ball having a diameter of 3 mm, with a mass ratio of activated carbon to milling balls of 1:1.

Equipment: A high-energy ball milling machine equipped with a milling pot having a volume of 1 L.

Procedure: The water filtration grade activated carbon was placed into the milling pot together with the milling balls at an equal mass ratio. The rotational speed of the milling pot was set in a range of 2.5-6.0 Hz (i.e., 150-600 rpm), and milling was performed continuously for 3-12 hours. By way of example, the milling speed was set to 300 rpm and milling was carried out for 3, 6, and 9 hours.

Product Obtained: Ball-milled water filtration grade activated carbon (hereinafter referred to as WFG-BM). Specifically, WFG-BM 3 h refers to a sample milled at 300 rpm for 3 hours, WFG-BM 6 h refers to a sample milled at 300 rpm for 6 hours, and WFG-BM 9 h refers to a sample milled at 300 rpm for 9 hours.

### 1.2 Spherification of Activated Carbon Particles

Objective: To modify irregularly shaped activated carbon particles into more rounded or spherical particles in order to improve packing density and uniformity when used in electrode fabrication.

Materials: Ball-milled activated carbon powder (WFG-BM) in an amount of 100-200 g.

Equipment: A mechanofusion reactor equipped with a water-cooling system.

Procedure: The activated carbon powder was introduced into the mechanofusion reactor and processed at a rotational speed in a range of 500-5,000 rpm for 30-60 minutes. By way of example, the rotational speed was set to 4,000 rpm for 30 minutes under a nitrogen atmosphere at room temperature, while operating the water-cooling system to control the processing temperature.

Product Obtained: Water filtration grade activated carbon subjected to both ball milling and mechanofusion (hereinafter referred to as WFG-BM+MF).

### 1.3 Heat Treatment of Activated Carbon

Objective: To reduce oxygen-containing functional groups and impurities in the activated carbon, thereby improving electrical conductivity, structural stability, and surface properties.

Materials: Spherified activated carbon (WFG-BM+MF) in an amount of 100-200 g.

Equipment: A tube furnace.

Procedure: The activated carbon subjected to mechanofusion (WFG-BM+MF) was placed in a ceramic tray and introduced into the tube furnace. The temperature was then increased to 600-900° C. under a flow of argon gas containing 5% hydrogen, and the heat treatment was maintained for 2 hours.

Product Obtained: Water filtration grade activated carbon subjected to ball milling, mechanofusion, and annealing (hereinafter referred to as WFG-BM+MF+AN).

The activated carbon products obtained from each processing step were subsequently characterized in detail to evaluate their structural, physical, and electrical properties, as described below.

### 2. Structural and Physical Characterization of Activated Carbon

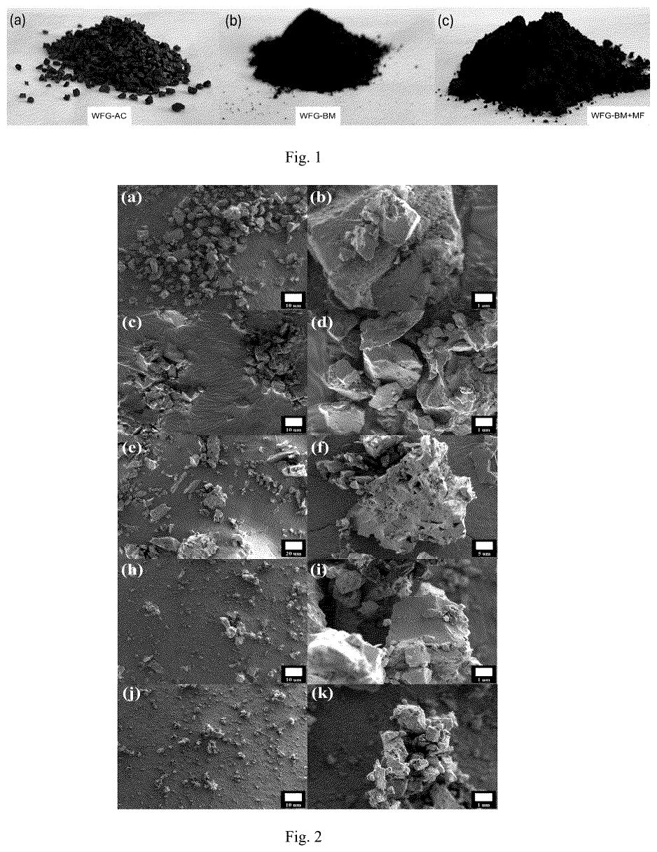

The structural and physical properties of the activated carbon samples prepared as described above were evaluated using various analytical techniques, including scanning electron microscopy (SEM), field emission scanning electron microscopy (FESEM), nitrogen adsorption-desorption analysis, X-ray photoelectron spectroscopy (XPS), and thermogravimetric analysis (TGA). The results are shown in FIGS. 1-5 and Tables 1-3, as described below.

### 2.1 Scanning Electron Microscopy (SEM) Analysis

FIGS. 1(a)-1(c) show SEM images of activated carbon samples obtained at each processing stage.

FIG. 1(a) shows water filtration grade activated carbon (WFG-AC) in the form of large granules, which is unsuitable for direct use in supercapacitors due to difficulties in slurry preparation, low surface area, and overly dense packing.

FIG. 1(b) shows water filtration grade activated carbon after ball milling (WFG-BM), wherein the particle size is reduced and particle size distribution becomes more uniform.

FIG. 1(c) shows water filtration grade activated carbon after ball milling and particle spherification by mechanofusion (WFG-BM+MF). This spherification step increases packing density and modifies the surface morphology, making the activated carbon more suitable for use as an electrode material in supercapacitors.

Additional particle size analysis revealed that a first commercially available supercapacitor-grade activated carbon (HP-AC1) has an average particle size of approximately 5.71 μm, untreated water filtration grade activated carbon (WFG-AC) has an average particle size of approximately 39.92 μm, and ball-milled water filtration grade activated carbon (WFG-BM) has an average particle size of approximately 3.06 μm.

FIGS. 2(a)-2(k) show FESEM images of activated carbon samples obtained at each processing stage, illustrating surface morphologies.

FIGS. 2(a) and 2(b) show a first type of commercially available supercapacitor-grade activated carbon (HP-AC1);

FIGS. 2(c) and 2(d) show a second type of commercially available supercapacitor-grade activated carbon (HP-AC2);

FIGS. 2(e) and 2(f) show untreated water filtration grade activated carbon (WFG-AC);

FIGS. 2(h) and 2(i) show water filtration grade activated carbon after ball milling (WFG-BM) to reduce the particle sizes; and

FIGS. 2(j) and 2(k) show water filtration grade activated carbon after ball milling and mechanofusion (WFG-BM+MF), which exhibits improved electrode-level packing density.

### 2.2 Nitrogen Adsorption-Desorption Analysis

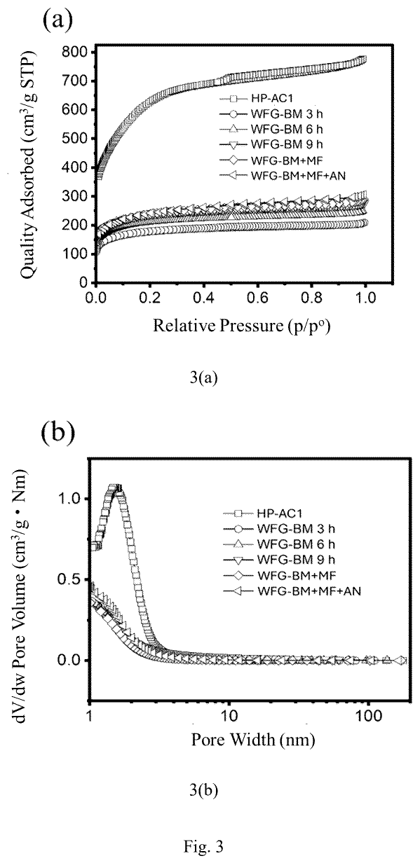

FIG. 3 shows results obtained from nitrogen adsorption analysis using the Brunauer-Emmett-Teller (BET) theory.

FIGS. 3(a) and 3(b) compare the specific surface area and pore width, respectively, of the first commercially available supercapacitor-grade activated carbon (HP-AC1), which exhibits the highest specific surface area, with those of water filtration grade activated carbon samples subjected to each processing step. The results indicate that the specific surface area of water filtration grade activated carbon increases progressively as a result of particle spherification by mechanofusion and subsequent heat treatment, as large agglomerates are transformed into finer particles.

### 2.3 Density Measurement

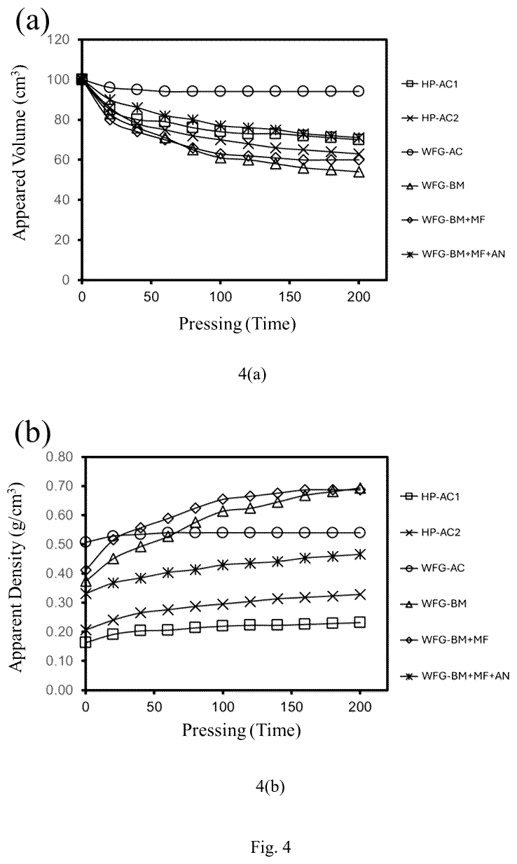

FIG. 4 shows density measurement results of activated carbon samples obtained using the ASTM D2854-96 (2015) standard test method for bulk density.

FIG. 4(a) shows the relationship between apparent volume and compaction time, starting from an initial volume of 100 cm³, and FIG. 4(b) shows the relationship between apparent density and compaction time. Bulk density and tapped density were calculated, wherein bulk density was measured prior to tapping and tapped density was measured after 200 tapping cycles. The results demonstrate that commercially available supercapacitor-grade activated carbon exhibits lower bulk density and tapped density compared to water filtration grade activated carbon treated according to the method of the present invention.

The physical property analysis results of each activated carbon sample are summarized in Table 1.

TABLE 1

| Activated | Surface | Pore | Pore | True | Bulk | Tapped |
|---|---|---|---|---|---|---|
| Carbon | Area | Volume | Size | Density | Density | Density |
| Sample | (m²/g) | (cm³/g) | (nm) | (cm³/g) | (cm³/g) | (cm³/g) |
| HP-AC1 | 2,347.27 | 1.18 | 2.01 | 2.18 | 0.16 | 0.23 |
| HP-AC2 | 1,568.54 | 0.75 | 1.96 | 2.12 | 0.21 | 0.33 |
| WFG-AC | 100.64 | 0.42 | 1.92 | 2.02 | 0.51 | 0.54 |
| WFG-BM | 867.17 | 0.42 | 1.92 | 2.12 | 0.37 | 0.69 |
| 9 h | | | | | | |
| WFG-BM + | 874.91 | 0.45 | 2.06 | 2.13 | 0.41 | 0.69 |
| MF | | | | | | |
| WFG-BM + | 885.86 | 0.47 | 2.14 | 2.18 | 0.33 | 0.47 |
| MF + AN | | | | | | |

### 2.4 X-ray Photoelectron Spectroscopy (XPS) Analysis

Results of X-ray photoelectron spectroscopy (XPS) wide-scan analysis of water filtration grade activated carbon (WFG-AC) and commercially available supercapacitor-grade activated carbon (HP-AC1) are shown in Table 2.

TABLE 2

| | Ar, at 0 s* | | | | | Ar, at 10 s** | | | | | |
|---|---|---|---|---|---|---|---|---|---|---|---|
| Sample | C | O | Si | Al | C:O | C | O | Si | Al | Fe | C:O |
| HP-AC1 | 97.05 | 2.75 | 0.05 | 0.00 | 35.29 | 97.23 | 1.47 | 0.11 | 0.00 | 0.05 | 66.14 |
| WFG-AC | 84.73 | 13.09 | 1.11 | 1.07 | 6.47 | 86.28 | 6.51 | 1.24 | 1.24 | 0.52 | 13.25 |

Notes:
*Surface sputtering of the sample using argon (Ar) gas for 0 seconds
**Surface sputtering of the sample using argon (Ar) gas for 10 seconds

From the analysis results, it was found that water filtration grade activated carbon (WFG-AC) contains a significantly higher amount of oxygen-containing impurities when compared with commercially available supercapacitor-grade activated carbon (HP-AC1).

### 2.5 Thermal Property Analysis

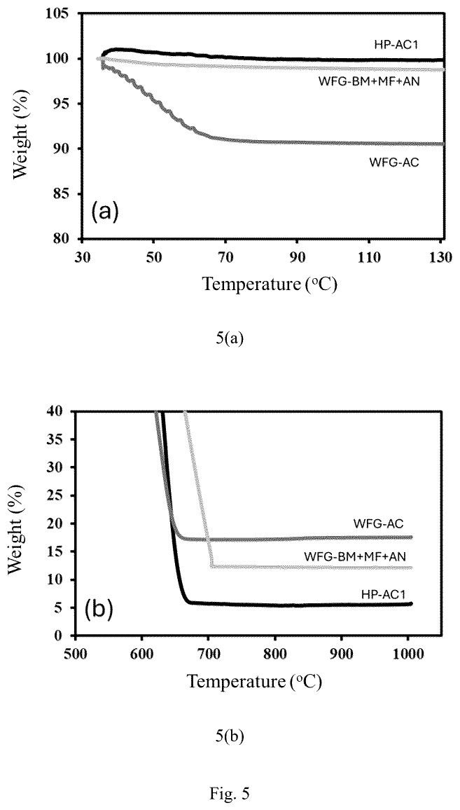

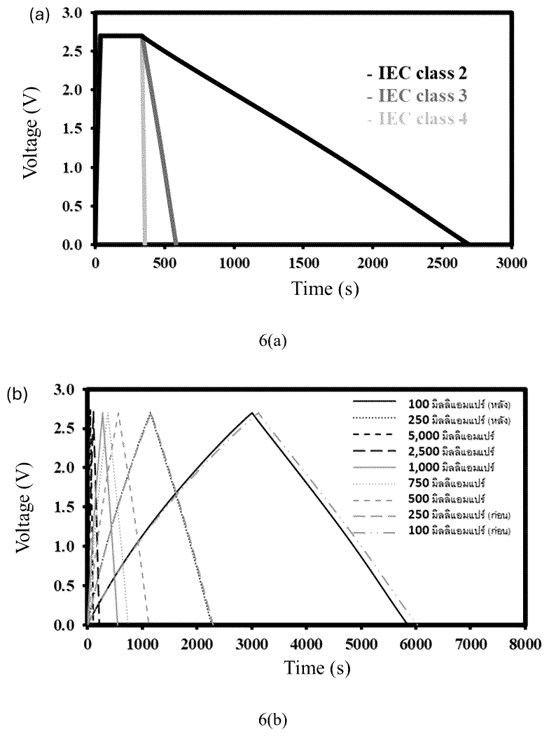

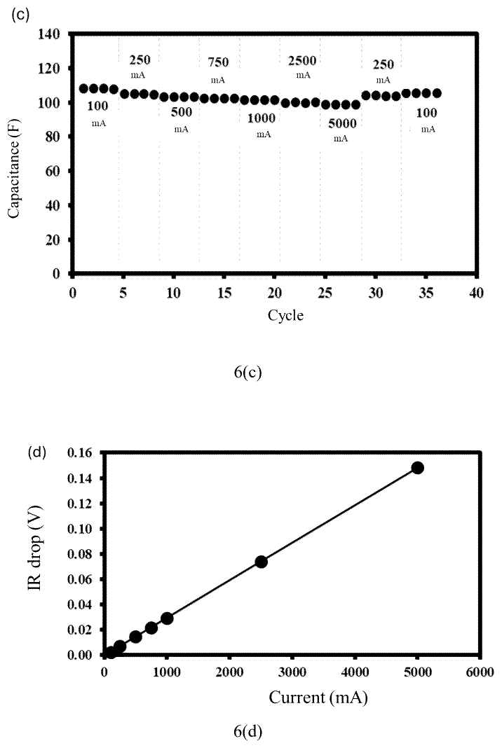

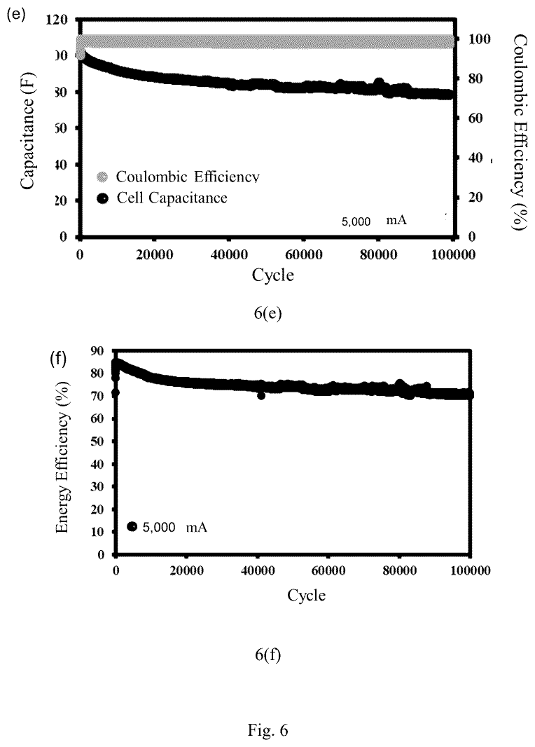

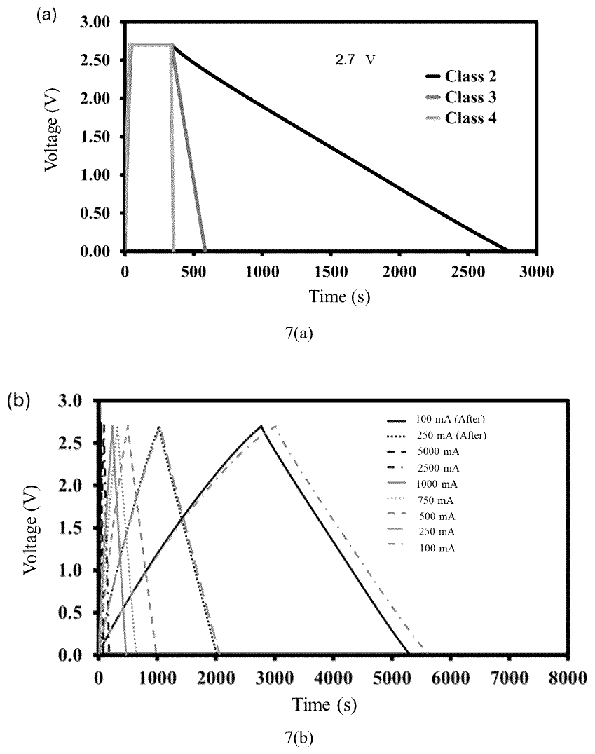

FIG. 5 shows the results of thermal property analysis of activated carbon samples obtained by thermogravimetric analysis (TGA), which indicates the thermal stability of the materials and is used to evaluate the suitability of activated carbon for applications requiring high thermal stability. The TGA results showing the onset temperatures of thermal decomposition and the final residual mass of each activated carbon sample are summarized in Table 3.

TABLE 3

| | First Decomposition Stage | | Second Decomposition Stage | | Final |
|---|---|---|---|---|---|
| | | Weight | | Weight | Mass at |
| | Temperature | Loss | Temperature | Loss | 1000° C. |
| Sample | (° C.) | (%) | (° C.) | (%) | (%) |
| HP-AC1 | 55.3-131.1 | −1.57 | 593.2-650.3 | −93.33 | 5.76 |
| WFG-AC | 45.7-57.9 | −8.91 | 561.2-643.3 | −72.59 | 17.62 |
| WFG- | 45.7-57.9 | −0.38 | 561.2-643.3 | −72.59 | 12.17 |
| BM + MF + AN | | | | | |

### 3. Applications and Performance Evaluation

The invention will now be further described with reference to performance evaluation results of activated carbon samples, focusing on their potential applications in energy storage devices, particularly supercapacitors. However, the examples and test results presented herein are intended solely to illustrate the invention and are not intended to limit the scope or aspects of the invention to the specific examples described.

Activated carbon treated according to the method of the present invention (WFG-BM+MF+AN) was used to fabricate electrodes and assemble cylindrical supercapacitor cells. Additional electrochemical performance testing was conducted in comparison with a commercially available supercapacitor-grade activated carbon (HP-AC1), milled water filtration grade activated carbon (WFG-BM), and water filtration grade activated carbon subjected to ball milling and mechanofusion (WFG-BM+MF), as described below.

### 3.1 Fabrication of Supercapacitor Electrodes

Electrodes were prepared by mixing activated carbon in an amount of 92 wt %, conductive carbon in an amount of 4 wt %, and a binder comprising carboxymethyl cellulose (CMC) and styrene-butadiene rubber (SBR) in an amount of 4 wt % to form a slurry. Deionized water was used as a solvent, and mixing was performed in a vacuum mixing tank at a rotational speed of 2,000 rpm for 12 hours. The viscosity of the slurry was adjusted to a range of 8,000-10,000 mPa's, after which the slurry was coated onto an aluminum foil current collector using a semi-continuous coating and drying system at a temperature of 120-125° C. to obtain electrodes having a thickness of 200 μm. The resulting electrodes were assembled into cylindrical cells using a polymer separator, and 1 M tetraethylammonium tetrafluoroborate (TEABF4) in acetonitrile (ACN) was used as an electrolyte.

### 3.2 Electrochemical Performance Test Results

Electrochemical performance test results of cylindrical supercapacitors fabricated using each activated carbon sample include:
(a) testing according to the IEC standard at 2.7 V;
(b) galvanostatic charge-discharge (GCD) profiles at various current rates;
(c) rate capability evaluation at currents ranging from 100 to 5,000 mA;
(d) galvanostatic charge-discharge (GCD) profiles illustrating internal resistance (IR) drop during performance testing;
(e) cycling stability testing under constant current (CC) charge-discharge at 5,000 mA; and
(f) energy efficiency analysis at 5,000 mA.

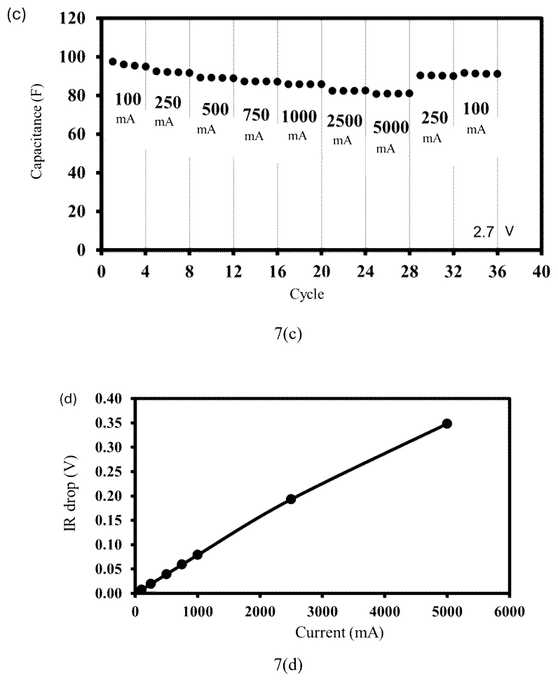

These results are shown in FIGS. 6-10. Parameters used for fabrication of the cylindrical supercapacitors employing each activated carbon sample are summarized in Tables 4-7, as described below.

### 3.2.1) Cylindrical Supercapacitor Using Commercial Supercapacitor-Grade Activated Carbon (HP-AC1)

TABLE 4

| | | |
|---|---|---|
| Electrode | Negative electrode: | Slurry weight ratio = Activated carbon: |
| Properties | Activated carbon | Conductive carbon:CMC:SBR = 92:4:2:2 |
| | | Specific surface area = 2254.30 m²/g |
| | | Electrical resistivity = 0.41 ± 0.05 Ω-cm |
| | | Coating thickness = 211 μm |
| | | Electrode thickness = 198.94 ± 3.95 μm (pressed |
| | | at 2 tons) |
| | | Active mass = 1.31 g |
| | Positive electrode: | Coating thickness = 211 μm |
| | Activated carbon | Electrode thickness = 198.94 ± 3.95 μm (pressed |
| | | at 2 tons) |
| | | Active mass = 1.31 g |

| | |
|---|---|
| Cell Weight | 25.68 ± 0.10 g (n = 97) |
| Electroltye | 1M TEABF₄ in ACN = 8.02 ± 0.15 g (n = 115) |
| Separator | Triple-layer Al-coated polymer separator (PP-PE-PP) |
| Cell Capacitances | at 2.7 V |
| | Class 2 110.14 F (S.D. = ±0.79%, n = 4) |
| | Class 3 108.74 F (S.D. = ±2.67%, n = 4) |
| | Class 4 105.95 F (S.D. = ±0.99%, n = 4) |
| | at 2.9 V |
| | Class 2 110.63 F (S.D. = ±1.42%, n = 4) |
| | Class 3 116.35 F (S.D. = ±0.23%, n = 4) |
| | Class 4 106.67 F (S.D. = ±4.36%, n = 4) |
| Normalized | Volumetric capacitance 6.88 F/Lref. |
| Capacitance | Gravimetric capacitance 4.27 F/gcell |
| | 10.25 F/gjelly |
| | 42.04 F/gAC |
| AC Internal | Before testing: 10.87 ± 0.53 mΩ (n = 97) |
| resistance at 1 | |
| kHz) | |

The electrochemical performance test results of cylindrical supercapacitors fabricated using a first type of commercially available supercapacitor-grade activated carbon (HP-AC1) are shown in FIGS. 6(a)-6(f).

### 3.2.2) Cylindrical Supercapacitor Using Milled Water Filtration Grade Activated Carbon (WFG-BM)

TABLE 5

| | | |
|---|---|---|
| Electrode | Negative electrode: | Slurry weight ratio = Activated carbon: |
| Properties | Activated carbon | Conductive carbon:CMC:SBR = 92:4:2:2 |
| | | Specific surface area = 867.17 m²/g |
| | | Electrical resistivity = 0.44 ± 0.09 Ω-cm |
| | | Coating thickness = 3 μm |
| | | Electrode thickness = 164.3 ± 3.7 μm |
| | | (pressed at 2 tons) |
| | | Active mass = 1.82 g |
| | Positive electrode: | Coating thickness = 211 μm |
| | Activated carbon | Electrode thickness = 164.3 ± 3.7 μm |
| | | (pressed at 2 tons) |
| | | Active mass = 1.82 g |

| | |
|---|---|
| Cell weight | 27.53 ± 0.28 g (n = 62) |
| Electrolyte | 1M TEABF₄ in ACN = 6.70 ± 0.13 g (n = 62) |
| Separator | Triple-layer Al-coated polymer separator (PP-PE-PP) |
| Cell | at 2.7 V |
| Capacitance | Class 2 98 F (S.D. = ±0.66%, n = 4) |
| | Class 3 97 F (S.D. = ±0.99%, n = 4) |
| | Class 4 84 F (S.D. = ±0.60%, n = 4) |
| | at 2.9 V |
| | Class 2 96 F (S.D. = ±0.82%, n = 4) |
| | Class 3 96 F (S.D. = ±1.62%, n = 4) |
| | Class 4 84 F (S.D. = ±4.98%, n = 4) |
| Normalized | Volumetric capacitance = 6.06 F/Lref. |
| Capacitance | Gravimetric capacitance 3.5 F/gcell |
| | 7.74 F/gjelly |
| | 26.64 F/gAC |
| AC Internal | 14.12 ± 0.47 mΩ (n = 41) |
| Resistance at | |
| 1 kHz | |

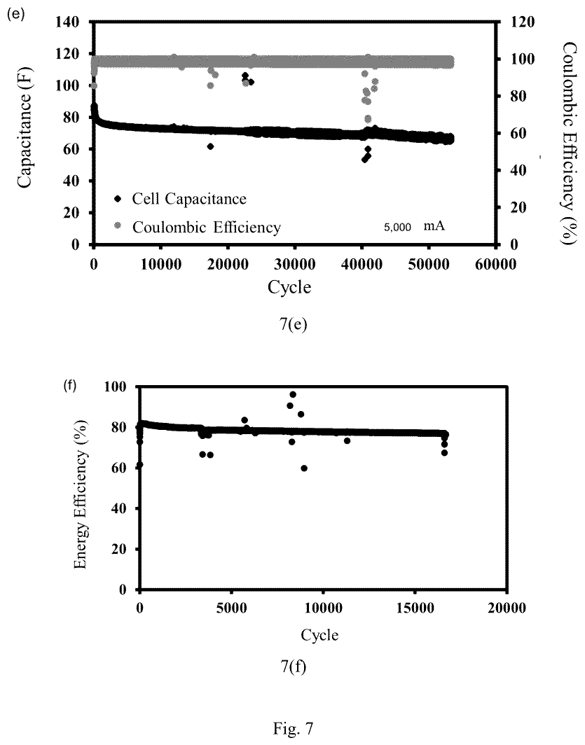

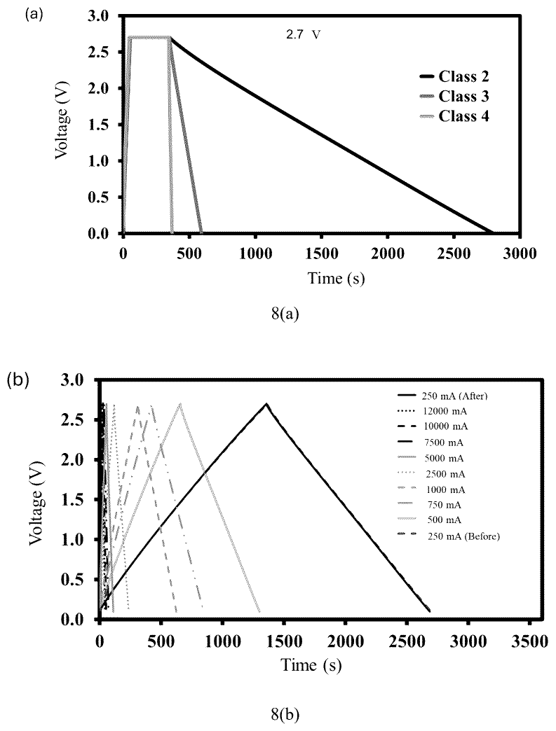

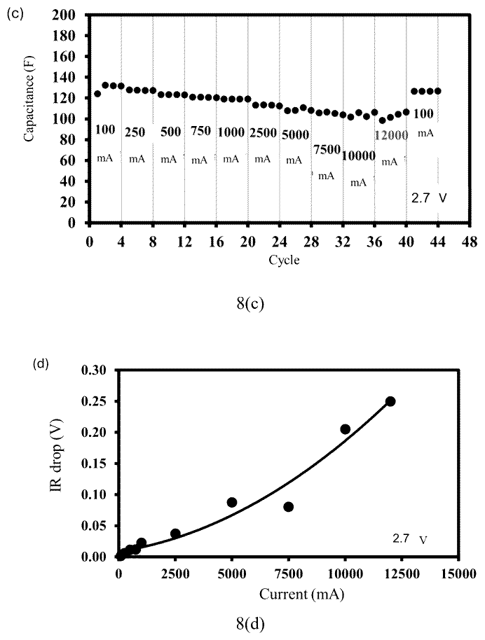

The electrochemical performance test results of the cylindrical supercapacitor fabricated using milled water filtration grade activated carbon (WFG-BM) are shown in FIGS. 7(a)-7(f).

### 3.2.3) Cylindrical Supercapacitor Using Milled and Mechanofused Water Filtration Grade Activated Carbon (WFG-BM+MF)

TABLE 6

| | | |
|---|---|---|
| Electrode | Negative Electrode: | Slurry weight ratio = Activated carbon: |
| Properties | Activated carbon | Conductive carbon:CMC:SBR = 92:4:2:2 |
| | | Specific surface area = 874.91 m²/g |
| | | Electrical resistivity = 0.47 ± 0.07 |
| | | Ω-cm (n = 18) |
| | | Coating thickness = 885.86 μm |
| | | Electrode thickness = 270 ± 5 μm |
| | | (pressed at 2 tons) |
| | | Active mass = 2.49 ± 0.07 g (n = 94) |
| | Positive Electrode: | Coating thickness = 300 μm |
| | Activated carbon | Electrode thickness = 270 ± 5 μm |
| | | (pressed at 2 tons) |
| | | Active mass = 2.49 ± 0.07 g (n = 94) |

| | |
|---|---|
| Cell Weight | 26.73 ± 0.09 g (n = 44) |
| Electrolyte | 1M TEABF₄ in ACN = 7.53 ± 0.05 g (n = 44) |
| Separator | Triple-layer Al-coated polymer separator (PP-PE-PP) |
| Cell | at 2.7 V |
| Capacitance | Class 2 130 ± 0.48 F (n = 4) |
| | Class 3 129 ± 0.46 F (n = 4) |
| | Class 4 120 ± 2.74 F (n = 4) |
| | at 2.9 V |
| | Class 2 129 ± 0.16 F (n = 4) |
| | Class 3 128 ± 1.06 F (n = 4) |
| | Class 4 119 ± 3.88 F (n = 4) |
| Normalized | Volumetric capacitance = 8.06 F/Lref. |
| Capacitance | Gravimetric capacitance 4.82 F/gcell |
| | 10.99 F/gjelly |
| | 25.90 F/gAC |
| AC Internal | 13.02 ± 0.47 mΩ (n = 44) |
| Resistance at | |
| 1 kHz | |

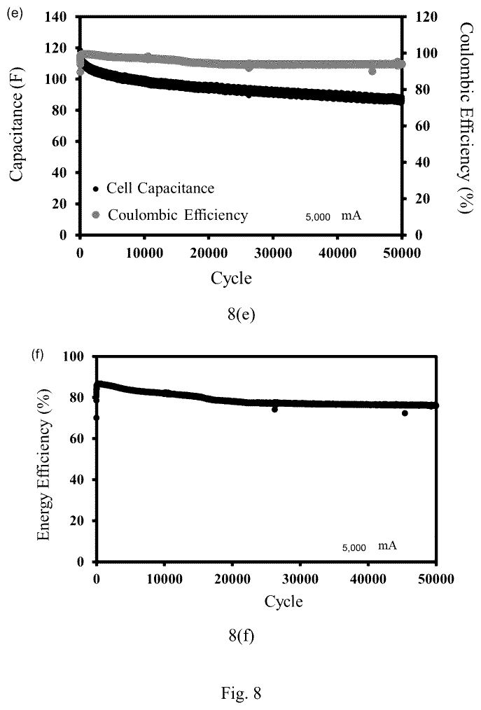

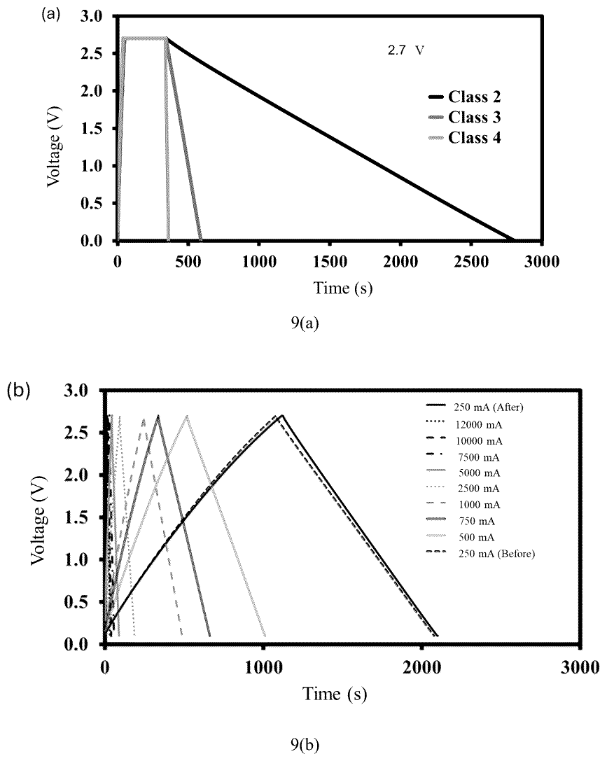

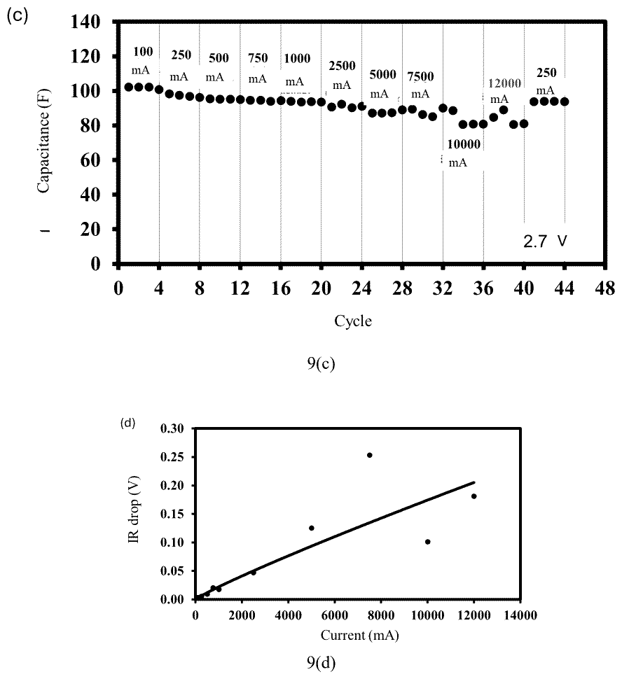

The electrochemical performance test results of the cylindrical supercapacitor fabricated using water filtration grade activated carbon subjected to milling and particle spherification by a mechanofusion process (WFG-BM+MF) are shown in FIGS. 8(a)-8(f).

### 3.2.4) Cylindrical Supercapacitor Using Activated Carbon Treated According to the Method of the Present Invention (WFG-BM+MF+AN)

TABLE 7

| | | |
|---|---|---|
| Electrode | Negative Electrode: | Slurry weight ratio = Activated carbon: |
| Properties | Activated carbon | Conductive carbon:CMC:SBR = 92:4:2:2 |
| | | Specific surface area = 885.86 m²/g |
| | | Electrical resistivity = 0.13 ± 0.09 |
| | | Ω-cm (n = 18) |
| | | Coating thickness = 300 μm |
| | | Electrode thickness = 238 ± 10 μm |
| | | (pressed at 2 tons) |
| | | Active mass = 2.19 ± 0.18 g (n = 60) |
| | Positive Electrode: | Coating thickness = 300 μm |
| | Activated carbon | Electrode thickness = 243 ± 9.6 μm |
| | | (pressed at 2 tons) |
| | | Active mass = 2.19 ± 0.18 g (n = 60) |

| | |
|---|---|
| Cell Weight | 28.01 ± 0.21 g (n = 39) |
| Electrolyte | 1M TEABF₄ in ACN = 7.38 ± 0.09 g (n = 39) (by volume) |
| Separator | Triple-layer Al-coated polymer separator (PP-PE-PP) |
| Cell | at 2.7 V |
| Capacitance | Class 2 104 ± 0.52 F (n = 4) |
| | Class 3 103 ± 1.70 F (n = 4) |
| | Class 4 103 ± 0.60 F (n = 4) |
| | at 2.9 V |
| | Class 2 101 ± 0.16 F (n =4) |
| | Class 3 105 ± 0.36 F (n = 4) |
| | Class 4 103 ± 1.59 F (n = 4) |
| Normalized | Volumetric capacitance 6.43 F/Lref. |
| Capacitance | Gravimetric capacitance 3.85 F/gcell |
| | 9.36 F/gjelly |
| | 24.52 F/gAC |
| AC Internal | 11.88 ± 0.39 mΩ (n = 39) |
| Resistance | |
| at 1 kHz | |

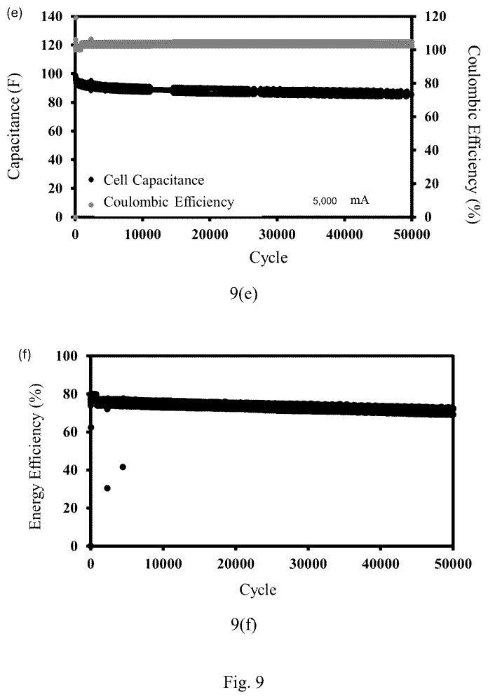

The electrochemical performance test results of the cylindrical supercapacitor fabricated using water filtration grade activated carbon treated according to the method of the present invention (WFG-BM+MF+AN) are shown in FIGS. 9(a)-9(f).

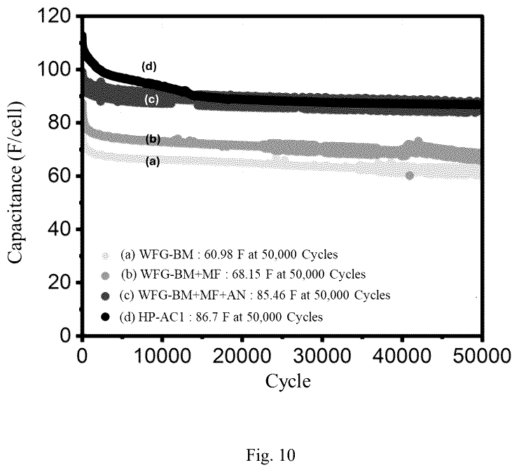

FIG. 10 shows a comparison of long-term cycling stability test results after 50,000 charge-discharge cycles at a current of 5,000 mA for cylindrical supercapacitors fabricated using different types of activated carbon as electrode materials.

Experimental results indicate that water filtration grade activated carbon (WFG-AC) as received, which is in the form of large granules (FIG. 1), is not suitable for electrode fabrication during slurry preparation. To address this issue, the particle size of the activated carbon was reduced by ball milling for 9 hours, which was determined to be the optimal duration (Table 1). However, when the ball-milled water filtration grade activated carbon (WFG-BM) was used to fabricate electrodes and assemble cylindrical supercapacitors, electrochemical performance testing revealed that the capacitance of each cell was lower than 100 F (Table 4), which is below the standard for this cell size. This limitation is attributed to the relatively low specific surface area of water filtration grade activated carbon (WFG-AC), particularly when compared with commercially available supercapacitor-grade activated carbon (HP-AC1).

To overcome the aforementioned capacitance limitation, the particle morphology of water filtration grade activated carbon (WFG-AC) was modified to a spherical shape (FIGS. 1(c) and 2(k)). This particle spherification enabled a higher electrode mass loading during electrode fabrication (Table 5), resulting in capacitance values exceeding 100 F per cell. However, as shown in FIG. 8(e), the capacitance retention remained limited, which is believed to result from a high impurity content, particularly oxygen-containing species, as confirmed by XPS analysis (Table 2) and TGA results (FIG. 5 and Table 3).

Accordingly, to further improve capacitance and long-term cycling stability, water filtration grade activated carbon subjected to ball milling and mechanofusion (WFG-BM+MF) was further heat-treated at 900° C. for 2 hours. This heat treatment eliminated low-temperature thermal decomposition behavior, as confirmed by TGA results (FIG. 5), indicating effective removal of oxygen-containing impurities (Table 3) that adversely affect cell stability and capacitance.

The method of the present invention, which combines particle size reduction, particle spherification via mechanofusion, and heat treatment or annealing, enables conventional low-cost water filtration grade activated carbon to exhibit performance comparable to that of commercially available supercapacitor-grade activated carbon, but at a significantly lower cost, as demonstrated in Table 7 and FIG. 10. The initial capacitance and long-term performance of the two activated carbon materials are similar. In particular, supercapacitors fabricated using commercially available supercapacitor-grade activated carbon (HP-AC1) and activated carbon treated according to the method of the present invention (WFG-BM+MF+AN) were able to retain capacitance values exceeding 85 F after 50,000 charge-discharge cycles.

These results demonstrate the potential of improved water filtration grade activated carbon as a more cost-effective alternative for use in supercapacitors in place of expensive commercially available supercapacitor-grade activated carbon, both in terms of initial performance and long-term operation. In other words, water filtration grade activated carbon (WFG-AC) can be upgraded to exhibit properties and performance comparable to those of commercial supercapacitor-grade activated carbon by employing the method of the present invention, which is low-cost and involves non-complex processing steps.

Moreover, due to the improved structural and surface properties, water filtration grade activated carbon treated according to the method of the present invention can also be applied to other applications, such as capacitive deionization, battery electrodes, and catalytic support materials.

In summary, the present invention provides a method for developing and improving low-cost, low-performance activated carbon into a high-performance carbon material suitable for use in energy storage technologies, such as supercapacitors, through particle size reduction, mechanofusion, and heat treatment under an inert atmosphere. The method is simple, cost-effective, and does not require special precursors. Furthermore, the invention demonstrates that low-cost activated carbon, particularly coconut shell-based activated carbon, can be modified to exhibit properties suitable for use in supercapacitors without the addition of transition metals or complex chemical processes. The physical and electrochemical properties of low-cost activated carbon are significantly enhanced through particle morphology modification by mechanofusion and annealing under an inert gas atmosphere, without reliance on chemical activating agents, making the method well-suited for industrial-scale production of supercapacitors.

### BEST MODE OF THE INVENTION

Best mode of the invention is as described in the detailed description of the invention.

1. A method for treating activated carbon, comprising the steps of:
(a) reducing a particle size of a starting activated carbon to obtain activated carbon powder;
(b) subjecting the activated carbon powder obtained from step (a) to a mechanofusion process to obtain activated carbon having spherical particles; and
(c) subjecting the activated carbon having spherical particles obtained from step (b) to a heat treatment,
wherein step (c) is carried out at a temperature in a range of 600-1,000° C. for 1-5 hours.

2. The method for treating activated carbon according to claim 1, wherein step (a) is performed by milling using a ball milling machine or a high-energy ball milling machine.

3. The method for treating activated carbon according to claim 2, wherein the milling is performed with a rotational speed of a milling pot in a range of 2.5-6.0 Hz or a milling speed in a range of 150-600 rpm for 3-12 hours.

4. The method for treating activated carbon according to claim 3, wherein the milling is performed at a milling speed in a range of 200-400 rpm for 7-9 hours.

5. The method for treating activated carbon according to claim 2, wherein the milling is performed using a high-energy ball milling machine comprising an inner milling pot and an outer milling pot, wherein a milling speed of the inner milling pot is in a range of 300-1,800 rpm, and a milling speed of the outer milling pot is in a range of 150-600 rpm for 3-12 hours.

6. The method for treating activated carbon according to claim 2, wherein the milling is performed using a mass ratio of the starting activated carbon to a milling ball in a range of 1:0.5-2.0.

7. The method for treating activated carbon according to claim 1, wherein the activated carbon powder obtained from step (a) has a particle size in a range of 1-5 micrometers.

8. The method for treating activated carbon according to claim 1, wherein the starting activated carbon is selected from water filtration grade activated carbon, coconut shell-based activated carbon, or a mixture thereof.

9. The method for treating activated carbon according to claim 1, wherein in step (b), the mechanofusion process is performed under an inert gas atmosphere at a rotational speed in a range of 500-5,000 rpm for 30-60 minutes.

10. The method for treating activated carbon according to claim 9, wherein in step (b), the mechanofusion process is performed at a rotational speed in a range of 4,000-5,000 rpm for 30-40 minutes.

11. The method for treating activated carbon according to claim 1, wherein the activated carbon having spherical particles obtained from step (b) has a particle size in a range of 2-6 micrometers.

12. The method for treating activated carbon according to claim 1, wherein step (c) is performed by annealing under an inert gas atmosphere at a temperature in a range of 800-900° C. for 2-3 hours.

13. The method for treating activated carbon according to claim 12, wherein the annealing is performed under an inert gas atmosphere comprising hydrogen in an amount of 1-10%.

14. The method for treating activated carbon according to claim 13, wherein the annealing is performed under an inert gas atmosphere comprising hydrogen in an amount of 1-5%.

15. Activated carbon produced by the method according to claim 1.

16. The activated carbon according to claim 15, having a specific surface area in a range of 200-900 m²/g and a bulk density in a range of 0.3-0.5 g/cm³.

17. An energy storage device comprising the activated carbon according to claim 15.
